(19) United States
(12) Patent Application Publication
(10) Pub. No.: US 2018/0335971 A1
(43) Pub. Date: Nov. 22, 2018

(54) CONFIGURABLE VIRTUALIZED NON-VOLATILE MEMORY EXPRESS STORAGE

(71) Applicant: Cisco Technology, Inc., San Jose, CA (US)

(72) Inventor: Sagar Borikar, San Jose, CA (US)

(21) Appl. No.: 15/596,206

(22) Filed: May 16, 2017

(51) Int. Cl. G06F 3/06; G06F 13/42; G06F 13/24

(52) U.S. Cl. CPC G06F 3/0635; G06F 3/0611; G06F 3/0685; G06F 2213/0026; G06F 13/24; G06F 3/0659; G06F 13/4282

(57) ABSTRACT

Presented herein are techniques for virtualizing functions of a Non-Volatile Memory Express (NVMe) controller that manages access to non-volatile memory such as a solid state drive. An example method includes receiving, at a Peripheral Component Interconnect Express (PCIe) interface card that is in communication with a PCIe bus, configuration information for virtual interfaces that support a non-volatile memory express interface protocol, wherein the virtual interfaces virtualize a NVMe controller, configuring the virtual interfaces in accordance with the configuration information, presenting the virtual interfaces to the PCIe bus, and receiving, by at least one of the virtual interfaces, from a host in communication with the at least one of the virtual interfaces via the PCIe bus, a message for a queue of the at least one of the virtual interfaces that is mapped to a queue of the non-volatile memory express controller.

### TECHNICAL FIELD

The present disclosure relates to accessing non-volatile memory via a virtualized interface card.

### BACKGROUND

In a data center, servers are generally deployed to support applications that rely on high performance and throughput from input/output (IO) subsystems. Typically, servers are deployed with containerized applications or hypervisor based applications. Applications running on a virtual machine (VM) or in containers also rely on high throughput from the IO subsystems. Given that flash-based storage presently performs substantially better than magnetic media, the adoption of flash-based storage is increasing exponentially. The desire for performance improvement has given birth to several new technologies such as non-volatile memory (NVM) express (NVMe) that enables, e.g., a solid state drive (SSD) to directly connect over a Peripheral Component Interconnect Express (PCIe) bus to a host, removing the need of a storage controller (e.g., a host bus adapter (HBA)) to manage the drive. Using NVMe, server operating systems can access an SSD directly, either from user space or kernel space, depending upon the type of application deployed.

### BRIEF DESCRIPTION OF THE DRAWINGS

FIG. 1 depicts a virtual interface card (VIC) or adapter that presents a plurality of virtual NVMe controllers to a host via a PCIe bus in accordance with an example embodiment.

FIG. 2 depicts the virtual interface card along with a unified computing system manager (UCSM) used to configure the virtual interface card, in accordance with an example embodiment.

FIG. 3 depicts the allocation of PCIe resources to virtual NVMes in accordance with an example embodiment.

FIG. 4 shows a mapping of QP memory addresses in the NVMe controller to the virtual NVMe controller memory addresses in the base address register (BAR) region, as well as an admin queue handler hosted by VIC logic, in accordance with an example embodiment.

FIG. 5 depicts a series of operations for handling admin queue messaging in accordance with an example embodiment.

FIG. 6 is a flow chart depicting a series of operations that may be performed by the virtual interface card in accordance with an example embodiment.

FIG. 7 depicts a device on which aspects of the several described embodiments may be implemented.

### DESCRIPTION OF EXAMPLE EMBODIMENTS

### Overview

Presented herein are techniques for virtualizing functions of a NVMe controller that manages access to non-volatile memory such as a SSD. An example method includes receiving, at a Peripheral Component Interconnect Express (PCIe) interface card that is in communication with a PCIe bus, configuration information for virtual interfaces that support a non-volatile memory express interface protocol, wherein the virtual interfaces virtualize a NVMe controller, configuring the virtual interfaces in accordance with the configuration information, presenting the virtual interfaces to the PCIe bus, and receiving, by at least one of the virtual interfaces, from a host in communication with the at least one of the virtual interfaces via the PCIe bus, a message for a queue of the at least one of the virtual interfaces that is mapped to a queue of the non-volatile memory express controller.

Also presented herein is a device, including an interface unit configured to enable network communications, a memory, and one or more processors coupled to the interface unit and the memory, and configured to: receive configuration information for virtual interfaces that support a non-volatile memory express interface protocol, wherein the virtual interfaces virtualize a non-volatile memory express controller, configure the virtual interfaces in accordance with the configuration information, present the virtual interfaces to a Peripheral Component Interconnect Express (PCIe) bus, and receive, by at least one of the virtual interfaces, from a host in communication with the at least one of the virtual interfaces via the PCIe bus, a message for a queue of the at least one of the virtual interfaces that is mapped to a queue of the non-volatile memory express controller.

### Example Embodiments

As noted, it is desired to enable direct connectivity between a host and an SSD drive using NVMe. However, implementations of NVMe and SSD drives can be expensive. Today's NVMe drives, without single root IO virtualization (SRIOV) support, present themselves as a single PCIe device to the host with a plurality of queue pairs, which can be used by the host to perform the IO on the storage behind the NVMe controller. As a hypervisor claims dominion over the device, any IO to the device from the guest (operating on the host) has to come to the hypervisor, and is then sent to the device with the hypervisor's intervention. This hypervisor intervention reduces the benefits of the fast media offered by NVMe enabled SSD drives. That is, although applications are running in a VM environment or in containerized space on the host, they still want to exploit the performance capabilities of the drives, but the hypervisor hampers full exploitation of this capability. In other words, it would be beneficial if applications could share the resources provided by the NVMe controller independently and directly without any restriction from the hypervisor.

Single Root IO virtualization provides one possible solution to enable direct connectivity between a host and an NVMe controller, but that solution has several drawbacks.

For example, SRIOV can be costly, it provides fixed size resources per virtual function (VF), and controls the VFs through physical functions (PFs) thus inhibiting the ability to work with the NVMe controller directly and thereby independently control VFs.

The embodiments described herein provide for sharing, configuring and enabling a third party NVMe controller as multiple clones with user defined configured queue pairs (QPs) per clone and without requiring support from an operating system-to-driver controller with custom software. A standard OS's support for NVMe controllers can be used to work with the clones of the controllers and provide sharing of the storage and controller as per deployment requirements.

For ease of explanation, the following acronyms are used throughout the instant description.

| | |
|---|---|
| PCIe | Peripheral Component Interconnect Express |
| VIC | Virtual Interface Card/Virtual Interface Control |
| vNIC | Virtual Network Interface Card |
| UCSM | Unified Computing Systems Manager |
| FI | Fabric Interconnect |
| UCS | Unified Computing System |
| OS | Operating Systems |
| BAR | Base Address Register |
| BIOS | Basic Input Output Software |
| BRT | Bar Resource Table configuration register |
| NVMe | Non Volatile Memory Express |
| SSD | Solid State storage Disk |
| MSIx | Message Signaled Interrupts |
| SRIOV | Single Root IO Virtualization |
| RC | Root Complex |
| FI | Fabric Interconnect |
| PF | Physical Function in SRIOV context |
| VF | Virtual Function in SRIOV context |

In a UCS ecosystem, management software which controls the FI ecosystem configures server and adapter attributes. The management software also specifies what kind of adapters servers can work with and what feature set will be available for a given host. This flexibility enables server administrators to efficiently use the resources across different virtual adapters. The embodiments described herein makes use of UCSM configurability to define the skeleton of the NVMe adapter that is to be presented to the host.

Typically, third party NVMe adapters come with a standard feature set such as 32 queue pairs, an indication of the size (amount of memory) that the controller controls. That feature set, however, is rigid and cannot be changed or efficiently used by different applications directly without a hypervisor's intervention.

In the instant embodiments, however, the host/server can have access to different versions of the same third party adapter with specific configurable properties.

3rd and 4^{th} generation Virtual Interface Cards' application specific integrated circuit (ASIC) support root complex functionality that allows working with third party adapters on the PCIe bus. By making use of this feature, a third party device can be configured and be presented to the host with a custom software interface that can setup hardware registers appropriately so that the host can experience the device as the software can define. In the instant embodiments, the host software cannot “see” the devices present on the PCIe bus behind the root complex. This gives flexibility to VIC logic to configure the presentation of virtual devices to the host.

As will be explained in more detail below, VIC logic (in the form of e.g. software instructions) discovers the devices behind the root complex using standard PCIe enumeration procedures. Once the devices are discovered, an inventory list is sent to the UCSM so that the inventory can be presented to an administrator. NVMe controller's details and feature set is also presented to the UCSM using standard protocols. The administrator can then define or configure a plurality of virtual NVMe controllers by carving out subsets of features such as queue pairs, SSD size, etc. and configure the UCSM to create multiple different (virtual) NVMe controllers, which will be presented to the server OS.

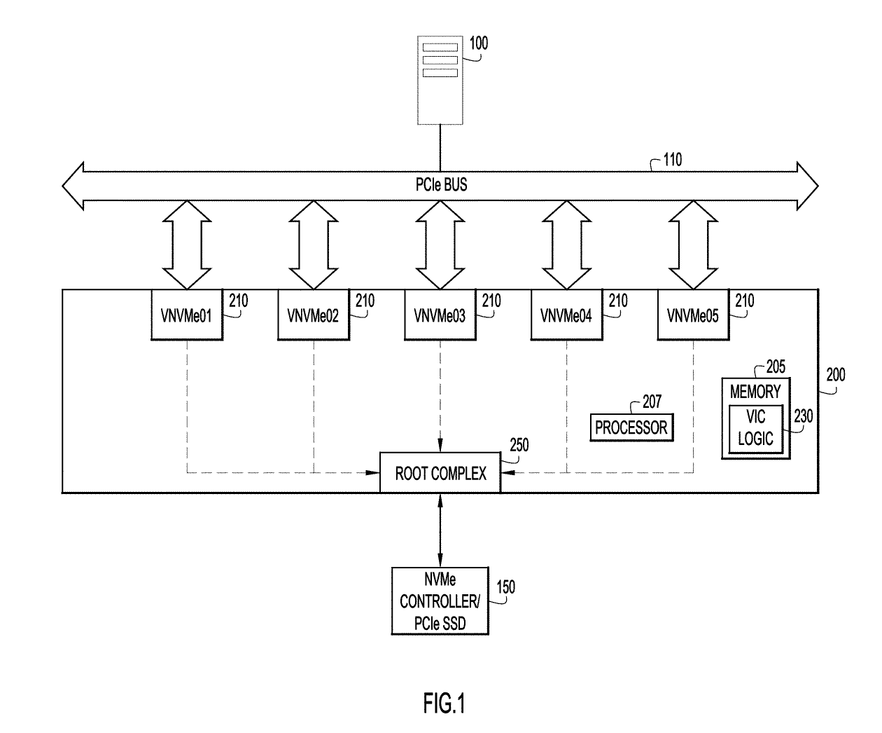

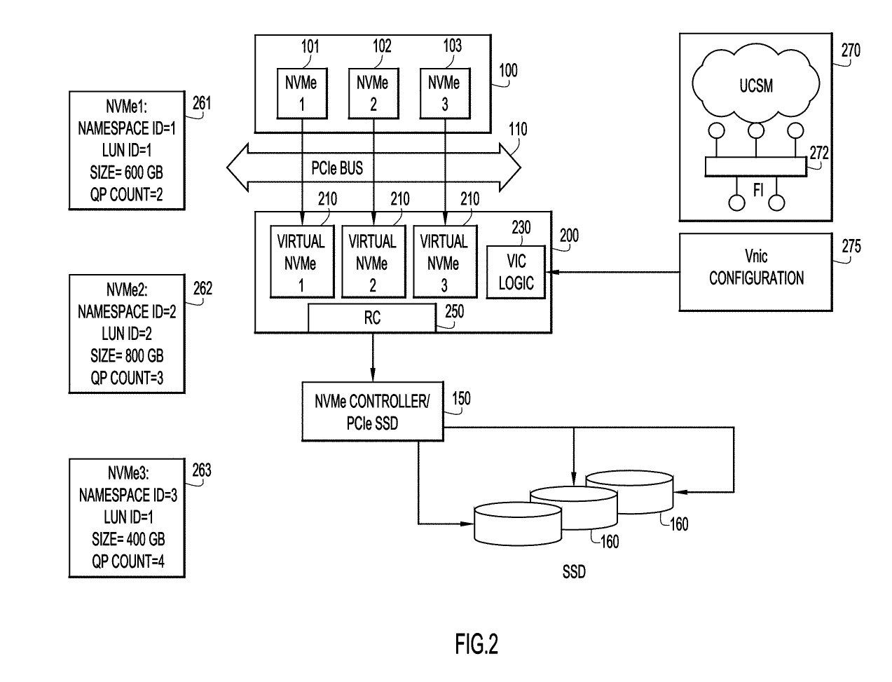

Reference is now made to FIG. 1, which depicts a virtual interface card or adapter 200 that presents a plurality of virtual NVMe controllers 210 (Vnvme01 . . . Vnvme05) to a host 100 via a PCIe bus 110 in accordance with an example embodiment. As shown, virtual interface card (VIC) 200 includes a root complex 250, which is in communication with NVMe controller 150, which may be integrated with a PCIe SSD drive 160 (shown in FIG. 2).

As mentioned, a given NVMe controller 150 disposed behind root complex 250 is discovered and enumerated by VIC logic 230 that is made operable with processor 207. The feature set of the NVMe controller 150 is then provided to a UCSM 270 (FIG. 2) so that the feature set of the NVMe controller 150 can be carved up and “cloned” into a plurality of virtual NVMe controllers 210 each with a subset of the full feature set of the NVMe controller 150. VIC logic 230 is configured with logic instructions to discover the NVMe 150, provide feature details thereof to UCSM 270, receive a plurality of virtual NVMe configurations, and establish and present those virtual NVMes 210 to host 100 via PCIe bus 110.

More details regarding the present embodiments are provided below in multiple sections, and with reference to FIG. 2, which depicts the virtual interface card along with a unified computing system manager (UCSM) used to configure the virtual interface card, in accordance with an example embodiment.

Virtual NVMe Device Configuration

The following describes how virtual NVMe devices 210 are configured. VIC logic 230 follows a standard PCI enumeration cycle to discover devices behind root complex 250 of VIC 200. When VIC logic 230 detects NVMe controller 150 based on, e.g., its class, VIC logic 230 loads driver software to learn the attributes and feature set of the SSD 160 and associated controller 150. The learned information is then passed to UCSM 270 via fabric interconnect 272. The learned information is then presented by UCSM, via a user interface (not shown), to an administrator. Using the user interface, the administrator can create multiple logical unit numbers (LUNs) and namespaces, create partitions in the media, and store the same in a database that represents the attributes/features/resources of the NVMe controller 150.

The LUNs and namespaces may then be mapped to different virtual NVMe devices 210. This mapping may be automatically performed by, e.g., declaring how many virtual NVMe devices are desired and then dividing the resources of NVMe controller 150/SSD 160 evenly among the virtual devices, or may be performed manually, thereby enabling an administrator to allocate available resources as desired among the virtual NVMe devices 210.

Once the configuration of different virtual devices is completed, UCSM 270 sends the configuration 275 to VIC logic 230. VIC logic 230 then creates virtual NVMe devices 210 based on the received configuration 275 and presents the devices 210 to the PCIe bus 110. As shown by configurations 261, 262, 263, VIC logic 230 prepares each NVMe device 210 by assigning it information such as LUN ID, Namespace ID, size, QP count, interrupt count, etc.

Taking configurations 261, 262 and 263 as examples, and assuming for purposes of discussion that all of the capabilities of NVMe controller 150/SSD 160 have been allocated to the several desired NVMes 210, it can be seen that, e.g., the total memory available on SSD 160 is 600+800+400=1,800 GB. Similarly, assuming all of the QP pairs were allocated, the NVMe controller 150 supports a total of 2+3+4=9 QP pairs. As those skilled in the art will appreciate, there may be more virtual NVMe devices and there may be more capabilities to allocate. FIG. 2 merely shows an example.

As a final operation, VIC logic 230 clones the necessary PCIe configuration space from the NVMe controller 150 and emulates that configuration space in the local memory of the VIC 200 to be presented to the host 100 as PCIe configuration space.

PCIe Configuration Resource Management

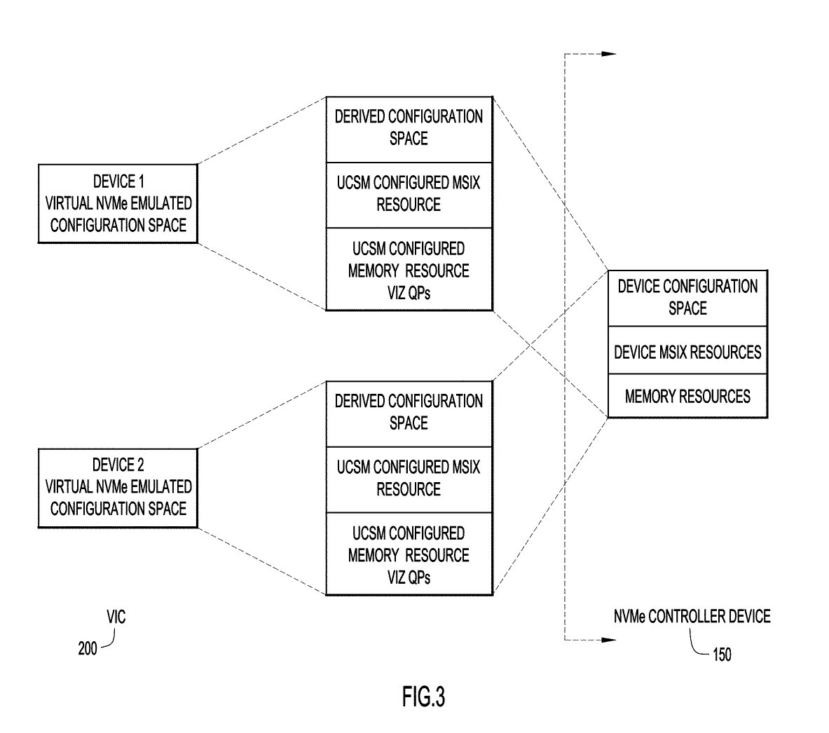

Reference is now made to FIG. 3, which depicts the allocation of PCIe resources to virtual NVMes in accordance with an example embodiment. Typical PCIe configuration space of any device includes message signaled interrupt (MSIx interrupt) configuration, memory/IO resources and basic configuration space in accordance with the PCIe standard. VIC logic 230 emulates the third party NVMe controller's 150 configuration space in local memory 205.

As part of generating configuration 275, UCSM 270 configures the number of interrupts per virtual device. VIC logic 230 allocates VIC ASIC resources which are mapped to actual device MSIx resources. For example, if the NVMe controller 150 supports 32 submission and completion queue pairs and 32 total MSIx interrupt resources, UCSM 270 can provision 16 QPs to one virtual NVMe device and 16 QPs to another virtual NVMe device. In such a case, VIC logic 230 allocates the 16 VIC ASIC interrupt resources per device and presents them in the MSIx capability of the configuration space.

In accordance with the NVMe standard, the location of the QPs and admin queue is fixed and follows a common format, which helps in carving out the QPs and interrupts that are mapped to virtual NVMe devices 210. Specifically, VIC logic 230 creates the base address register (BAR) resources, which are directly mapped to the actual QPs present in the third party NVMe device 150. There is 1:1 mapping of the queue pairs present in the third party NVMe device 150 and what is presented in the virtual NVMe device's 150 BAR space.

The only exception to the 1:1 mapping is the admin queue, since there is only one admin queue in the NVMe controller 150 which gets shared across the NVMe controller 150. As such, VIC logic 230 creates a per device virtual admin queue in local memory which is handled differently from the submission/completion queue pair. Thus, VIC logic 230 creates the PCIe configuration space of virtual NVMe devices that includes the derived configuration space of the NVMe controller 150, MSIx interrupts resources and memory resources, as shown in FIG. 3.

When software executing on host 100 configures the MSIx interrupt, it places the message data and address in the virtual NVMe device's MSIx capability's memory. VIC logic 230 internally updates the address and data in the translated vector of the actual MSIx resource in the NVMe controller 150. As a result, when the NVME controller 150 raises an interrupt, it actually gets translated to the host device MSIx pointer.

The root complex configuration enabled the translation from the NVMe controller 150 to memory of the host More specifically, VIC logic 230 maps the NVMe controller's configuration space appropriately to the emulated configuration space such that individual configuration space of a virtual NVMe device 210 is an exact replica of that of the NVMe controller 150, but access to the emulated configuration space does not go directly to the configuration space of the NVMe controller 150.

Queue Pair Management

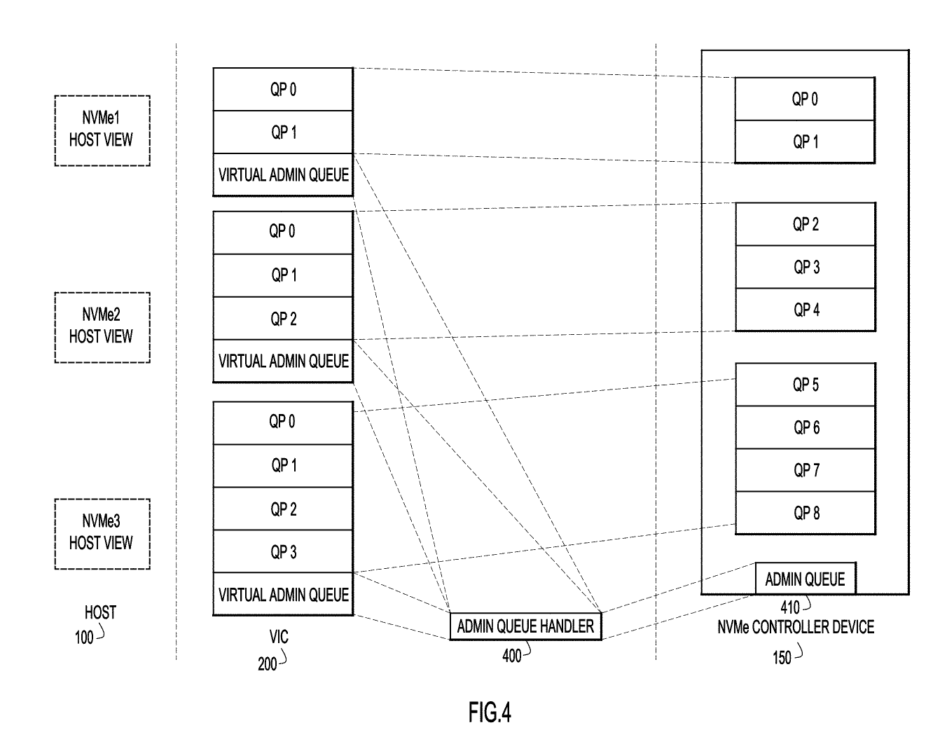

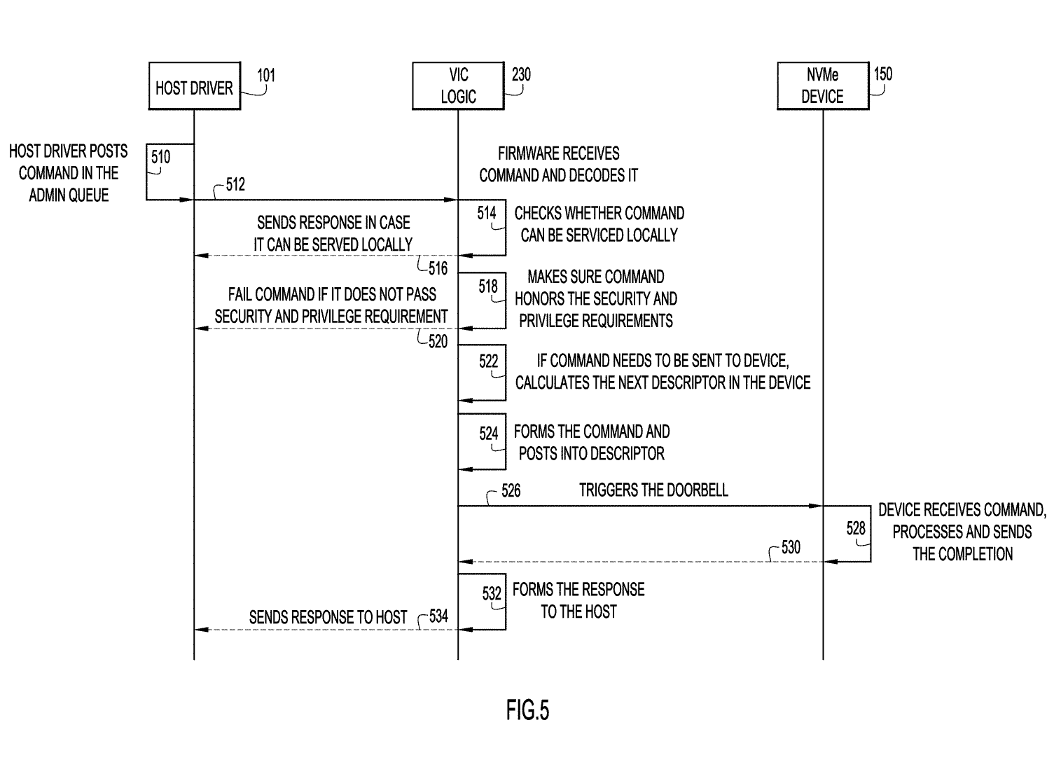

FIG. 4 shows a mapping of the actual QP memory addresses in the NVMe controller to the virtual NVMe controller memory addresses in the BAR region, as well as an admin queue handler hosted by VIC logic, in accordance with an example embodiment. As shown, VIC logic 230 maps the actual QP memory addresses in the NVMe controller to the virtual NVMe controller memory addresses in the BAR region. When a host driver (101 in FIG. 5) places a command (or message) in the submission queue (of a QP pair), the command ends up in the NVMe controller submission queue index. While there is 1:1 mapping between the virtual NVMe device's QPs to the third party's NVMe device QPs, there is no VIC logic involved in issuing commands to the NVMe controller. This improves the performance of the IO channel due to minimum overhead of software intervention. Once the third party NVMe controller 150 completes the command, it places the result in the completion queue corresponding to the submission queue (of the QP pair) and asserts the MSIx interrupt.

NVMe Admin Queue Management

The admin queue 410 of the NVMe device 150 is operable as a control channel to issue control commands to modify a namespace, retrieve QP info, attributes, etc. As noted, there is a single admin queue 410 in a given NVMe controller 150 so that admin queue 410 cannot be mapped directly to every virtual NVMe controller 210. Accordingly, in accordance with an embodiment, VIC logic 230 emulates admin queue 410 on behalf of every virtual NVMe device 210 using admin queue handler 400 that handles the command from the host 100, as illustrated in FIG. 5.

Specifically, FIG. 5 depicts a series of operations for handling admin queue messaging in accordance with an example embodiment. Preliminarily, as shown in FIG. 4, each virtual device has its own virtual admin queue 420 mapped by VIC logic 230. In this context, at 510, a host driver places a command in the admin queue of given virtual NVMe device 210, and, at 512, VIC logic 230 traps the command and performs validity and security checks on the command. At 514, VIC logic 230 determines whether the command can be serviced locally or whether it should be serviced by the actual NVMe controller 150 based on the database it has created per device.

If the command can be serviced locally then at 516 a response is sent to the host driver 101.

If the command cannot be serviced locally, and should instead be sent to the NVMe device 150, VIC logic 230 performs a security check at 518 to ensure that the command is non-destructive to other queue pairs by ensuring that the command honors security and privilege requirements. The security check may also confirm that the command does not change the policies enforced by the UCSM 270. It is noted that many commands are read-only and hence the amount of checking performed can be limited.

At 520, if for whatever reason the command did not pass the security check, a failure notification may be sent to host driver 110.

At 522, and assuming the security check completed successfully, VIC logic 230 determines or calculates the next descriptor in the admin queue 410 and, at 524, posts the command on behalf of the virtual NVMe device 210, and at 526, triggers the doorbell of the NVMe device 150.

At 528 and 530, the NVMe device 150 receives the command, processes the same and sends a completion command toward the host driver 101.

At 532, VIC logic 230 intercepts the command and, in turn, forms a response to the host driver 101, and at 534 sends the response to the host driver 101. The commands are managed asynchronously. Hence managing command IDs and mapping to the appropriate virtual NVMe 210 is performed in the admin queue handler 400 (FIG. 4).

NVMe Data Path Management

In an implementation, VIC logic 230 does not play any role (or has only a minimal role) in the data path so as to improve performance and have minimum overhead. The features described below enable the IO path to be independent of VIC logic 230.

At the time of creation of a virtual NVMe device 210, VIC logic 230 enables the root complex 250 hardware to configure the upstream address range in an access control list (ACL) table. This mapping is performed in terms of the VIC 200 index mapped to virtual device 210 and the corresponding address range. Once the hardware is setup, any upstream transaction requiring host address memory access from the virtual NVMe device 210 is translated directly by the hardware on VIC 200. [This is hardware functionality allows direct memory access (DMA) to host 100 through VIC 200 without software intervention, improving overall performance.

Further, when a host driver places a read/write request in a queue pair (QP) mapped to a virtual NVMe device, the virtual queue pair is already actually mapped to the translated queue pair in the NVMe device. Consequently, any command pushed to the virtual device's queue pair, is actually placed directly into the NVMe device's 150 translated queue pair.

Further still, descriptor management is performed by host driver 101 directly as the host driver 101 is actually working on a real queue pair through the proxy queue pair mapped by VIC logic 230 in the BAR region.

Also, the host driver 101 triggers the doorbell of the NVMe device indicating that work is to be performed by the NVMe device. That is, VIC logic 230 maps the NVMe device's memory into the emulated device memory BAR resource. Any writes to the emulated doorbell by the host driver 101 will thus be translated and directed to the NVMe device's doorbell register. The translation happens inside VIC 200 based on the configuration established by VIC logic 230.

Based on the type of command, the actual NVMe device 150 performs the IO to and from the host memory. Finally, the preconfigured ACL resources enable the transfer to occur directly and managed by VIC hardware (e.g., an ASIC) thereby avoiding software intervention.

In accordance with the embodiments described herein, a real NVMe device 150 is cloned into multiple virtual NVMe devices 210 of the same type with configurable resources, optimizing the utilization of the resources in terms of server applications.

As will be appreciated by those skilled in the art based on the foregoing, the different virtual NVMe devices 210 can be deployed independently by an administrator and be mapped to different applications. That is, the approach described herein provides significant flexibility in mapping any number of QPs from the actual NVMe device 150 to the virtual NVMe devices 210. As such, a user/administrator can deploy different devices based on need and priority of the applications that are going to make use of the storage subsystem.

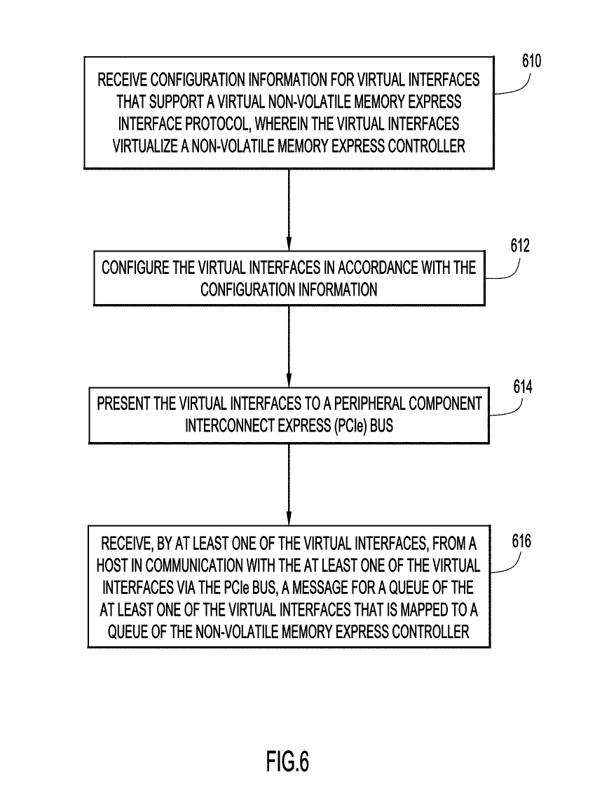

FIG. 6 is a flow chart depicting a series of operations that may be performed by the virtual interface card, e.g., VIC logic 230, in accordance with an example embodiment. At 610, the VIC receives configuration information for virtual interfaces that support a non-volatile memory express (NVMe) interface protocol, wherein the virtual interfaces virtualize an NVMe controller. At 612, the VIC is configured to configure the virtual interfaces in accordance with the configuration information. At 614, the VIC presents the virtual interfaces to a Peripheral Component Interconnect Express (PCIe) bus. At 616, the VIC receives, by at least one of the virtual interfaces, from a host in communication with the at least one of the virtual interfaces via the PCIe bus, a message for a queue of the at least one of the virtual interfaces that is mapped to a queue of the NVMe controller.

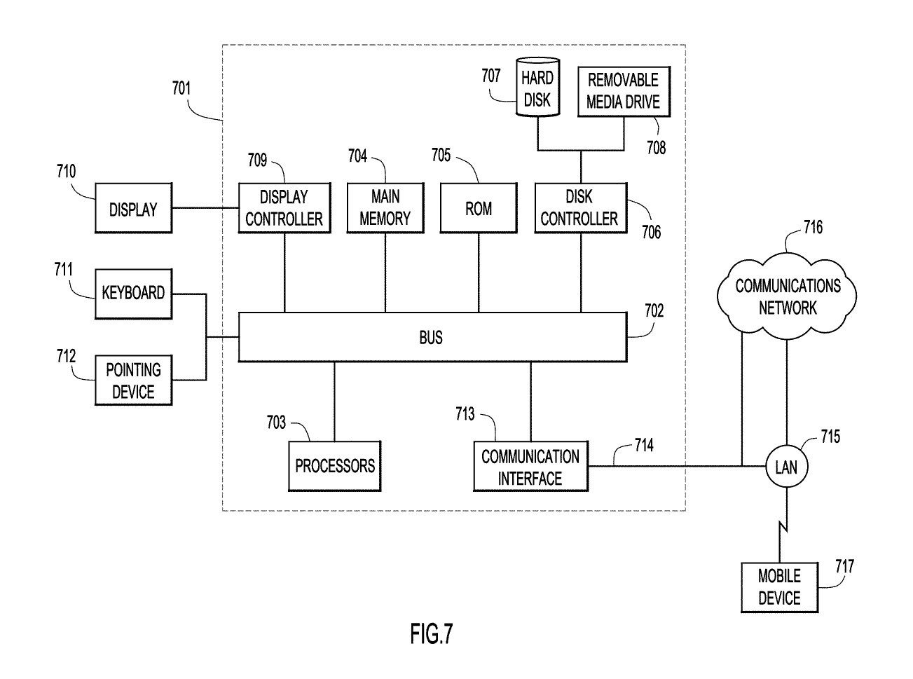

In accordance with an embodiment, UCSM 270 may be implemented on or as a computer system 701, as shown in FIG. 7. The computer system 701 may be programmed to implement a computer based device. The computer system 701 includes a bus 702 or other communication mechanism for communicating information, and a processor 703 coupled with the bus 702 for processing the information. While the figure shows a single block 703 for a processor, it should be understood that the processor 703 represents a plurality of processors or processing cores, each of which can perform separate processing. The computer system 701 may also include a main memory 704, such as a random access memory (RAM) or other dynamic storage device (e.g., dynamic RAM (DRAM), static RAM (SRAM), and synchronous DRAM (SD RAM)), coupled to the bus 702 for storing information and instructions (e.g., the logic to perform the configuration functionality described herein) to be executed by processor 703. In addition, the main memory 704 may be used for storing temporary variables or other intermediate information during the execution of instructions by the processor 703.

The computer system 701 may further include a read only memory (ROM) 705 or other static storage device (e.g., programmable ROM (PROM), erasable PROM (EPROM), and electrically erasable PROM (EEPROM)) coupled to the bus 702 for storing static information and instructions for the processor 703.

The computer system 701 may also include a disk controller 706 coupled to the bus 702 to control one or more storage devices for storing information and instructions, such as a magnetic hard disk 707, and a removable media drive 708 (e.g., floppy disk drive, read-only compact disc drive, read/write compact disc drive, flash drive, USB drive, compact disc jukebox, tape drive, and removable magneto-optical drive). The storage devices may be added to the computer system 701 using an appropriate device interface (e.g., small computer system interface (SCSI), integrated device electronics (IDE), enhanced-IDE (E-IDE), direct memory access (DMA), or ultra-DMA).

The computer system 701 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors, graphics processing units, and digital signal processors may individually, or collectively, are types of processing circuitry. The processing circuitry may be located in one device or distributed across multiple devices.

The computer system 701 may also include a display controller 709 coupled to the bus 702 to control a display 710, such as a cathode ray tube (CRT), liquid crystal display (LCD), light emitting diode (LED) display, etc., for displaying information to a computer user. The computer system 701 may include input devices, such as a keyboard 711 and a pointing device 712, for interacting with a computer user and providing information to the processor 703. The pointing device 712, for example, may be a mouse, a trackball, or a pointing stick for communicating direction information and command selections to the processor 703 and for controlling cursor movement on the display 710. In addition, a printer may provide printed listings of data stored and/or generated by the computer system 701.

The computer system 701 performs processing operations of the embodiments described herein in response to the processor 703 executing one or more sequences of one or more instructions contained in a memory, such as the main memory 704. Such instructions may be read into the main memory 704 from another computer readable medium, such as a hard disk 707 or a removable media drive 708. One or more processors in a multi-processing arrangement may also be employed to execute the sequences of instructions contained in main memory 704. In alternative embodiments, hard-wired circuitry may be used in place of or in combination with software instructions. Thus, embodiments are not limited to any specific combination of hardware circuitry and software.

As stated above, the computer system 701 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), USB drives, or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 701, for driving a device or devices for implementing the described embodiments, and for enabling the computer system 701 to interact with a human user. Such software may include, but is not limited to, device drivers, operating systems, development tools, and applications software. Such computer readable storage media further includes a computer program product for performing all or a portion (if processing is distributed) of the processing presented herein.

The computer code may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 701 also includes a communication interface 713 coupled to the bus 702. The communication interface 713 provides a two-way data communication coupling to a network link 714 that is connected to, for example, a local area network (LAN) 715, or to another communications network 716. For example, the communication interface 713 may be a wired or wireless network interface card or modem (e.g., with SIM card) configured to attach to any packet switched (wired or wireless) LAN or WWAN. As another example, the communication interface 713 may be an asymmetrical digital subscriber line (ADSL) card, an integrated services digital network (ISDN) card, or a modem to provide a data communication connection to a corresponding type of communications line. Wireless links may also be implemented. In any such implementation, the communication interface 713 sends and receives electrical, electromagnetic or optical signals that carry digital data streams representing various types of information.

The network link 714 typically provides data communication through one or more networks to other data devices. For example, the network link 714 may provide a connection to another computer through a local area network 715 (e.g., a LAN) or through equipment operated by a service provider, which provides communication services through the communications network 716. The network link 714 and the communications network 716 use, for example, electrical, electromagnetic, or optical signals that carry digital data streams, and the associated physical layer (e.g., CAT 5 cable, coaxial cable, optical fiber, etc.). The signals through the various networks and the signals on the network link 714 and through the communication interface 713, which carry the digital data to and from the computer system 701 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 701 can transmit and receive data, including program code, through the network(s) 715 and 716, the network link 714 and the communication interface 713.

It is noted that the memory 205 and processor 207 of VIC 200 may be implemented similarly as the memory 704 and processor 703 described above, and interconnected with one another on a PCIe compliant interface card.

In summary, in one form, a method is provided. The method includes receiving, at a Peripheral Component Interconnect Express (PCIe) interface card that is in communication with a PCIe bus, configuration information for virtual interfaces that support a non-volatile memory express interface protocol, wherein the virtual interfaces virtualize a non-volatile memory express controller; configuring the virtual interfaces in accordance with the configuration information; presenting the virtual interfaces to the PCIe bus; and receiving, by at least one of the virtual interfaces, from a host in communication with the at least one of the virtual interfaces via the PCIe bus, a message for a queue of the at least one of the virtual interfaces that is mapped to a queue of the non-volatile memory express controller.

The configuration information may include, for each one of the plurality of virtual interfaces at least a namespace identifier, a logical unit number, a memory amount, and a queue pair count. The memory amount and queue pair count for respective ones of the virtual interfaces may be different.

The method may further include cloning, for each of the virtual interfaces, PCIe configuration space from the non-volatile memory express controller and storing in memory of the PCIe interface card a resulting cloned PCIe configuration space. Presenting the virtual interfaces to the PCIe bus may include presenting the PCIe configuration space to the host.

Configuring the virtual interfaces in accordance with the configuration information may include mapping message signal interrupt resources of the non-volatile memory express controller to the virtual interfaces

The method may further include determining whether the message can be serviced locally within the PCIe interface card; and when the message can be serviced locally within the PCIe interface card, sending a response to the message to the host via the PCIe bus.

The method may still further include forming a command from the message and posting the command in a descriptor; and triggering a doorbell of the non-volatile memory express controller such that the command is supplied to the non-volatile memory express controller. The method may also include receiving, in response to the command, a completion message from the non-volatile memory express controller; and sending the completion message to the host.

The method may also include virtualizing an administration queue of the non-volatile memory express controller; and handling administration queue messages via an administration queue handler hosted by the PCIe interface card.

In one implementation, the non-volatile memory express controller controls access to a solid state drive.

In another embodiment, a device is provided. The device includes an interface unit configured to enable network communications; a memory; and one or more processors coupled to the interface unit and the memory, and configured to: receive configuration information for virtual interfaces that support a non-volatile memory express interface protocol, wherein the virtual interfaces virtualize a non-volatile memory express controller; configure the virtual interfaces in accordance with the configuration information; present the virtual interfaces to a Peripheral Component Interconnect Express (PCIe) bus; and receive, by at least one of the virtual interfaces, from a host in communication with the at least one of the virtual interfaces via the PCIe bus, a message for a queue of the at least one of the virtual interfaces that is mapped to a queue of the non-volatile memory express controller.

The configuration information may include, for each one of the virtual interfaces at least a namespace identifier, a logical unit number, a memory amount, and a queue pair count. The memory amount and queue pair count for respective ones of the plurality of virtual interfaces may be different.

The one or more processors may be further configured to: clone, for each of the plurality of virtual interfaces, PCIe configuration space from the non-volatile memory express controller and store in the memory a resulting cloned PCIe configuration space; and present the PCIe configuration space to the host.

The one or more processors may be further configured to: map message signal interrupt resources of the non-volatile memory express controller to the plurality of virtual interfaces.

The one or more processors may be further configured to: determine whether the message can be serviced locally; and when the message can be serviced locally, send a response to the message to the host via the PCIe bus.

The non-volatile memory express controller may control access to a solid state drive.

In still another embodiment, a non-transitory tangible computer readable storage media encoded with instructions is provided that, when executed by at least one processor is configured to receive configuration information for virtual interfaces that support a non-volatile memory express interface protocol, wherein the virtual interfaces virtualize a non-volatile memory express controller; configure the virtual interfaces in accordance with the configuration information; present the virtual interfaces to a Peripheral Component Interconnect Express (PCIe) bus; and receive, by at least one of the virtual interfaces, from a host in communication with the at least one of the virtual interfaces via the PCIe bus, a message for a queue of the at least one of the virtual interfaces that is mapped to a queue of the non-volatile memory express controller.

The configuration information may include, for each one of the virtual interfaces at least a namespace identifier, a logical unit number, a memory amount, and a queue pair count.

The instructions further cause the processor to: clone, for each of the virtual interfaces, PCIe configuration space from the non-volatile memory express controller and store in the memory a resulting cloned PCIe configuration space; and present the PCIe configuration space to the host

The above description is intended by way of example only. Various modifications and structural changes may be made therein without departing from the scope of the concepts described herein and within the scope and range of equivalents of the claims.

What is claimed is:

1. A method comprising:
receiving, at a Peripheral Component Interconnect Express (PCIe) interface card that is in communication with a PCIe bus, configuration information for virtual interfaces that support a non-volatile memory express interface protocol, wherein the virtual interfaces virtualize a non-volatile memory express controller;
configuring the virtual interfaces in accordance with the configuration information;
presenting the virtual interfaces to the PCIe bus; and
receiving, by at least one of the virtual interfaces, from a host in communication with the at least one of the virtual interfaces via the PCIe bus, a message for a queue of the at least one of the virtual interfaces that is mapped to a queue of the non-volatile memory express controller.

2. The method of claim 1, wherein the configuration information comprises, for each one of the plurality of virtual interfaces at least a namespace identifier, a logical unit number, a memory amount, and a queue pair count.

3. The method of claim 2, wherein the memory amount and queue pair count for respective ones of the virtual interfaces is different.

4. The method of claim 1, further comprising:
cloning, for each of the virtual interfaces, PCIe configuration space from the non-volatile memory express controller and storing in memory of the PCIe interface card a resulting cloned PCIe configuration space; and
wherein presenting the virtual interfaces to the PCIe bus comprises presenting the PCIe configuration space to the host.

5. The method of claim 1, wherein configuring the virtual interfaces in accordance with the configuration information comprises mapping message signal interrupt resources of the non-volatile memory express controller to the virtual interfaces.

6. The method of claim 1, further comprising:
determining whether the message can be serviced locally within the PCIe interface card; and
when the message can be serviced locally within the PCIe interface card, sending a response to the message to the host via the PCIe bus.

7. The method of claim 1, further comprising:
forming a command from the message and posting the command in a descriptor; and
triggering a doorbell of the non-volatile memory express controller such that the command is supplied to the non-volatile memory express controller.

8. The method of claim 7, further comprising:
receiving, in response to the command, a completion message from the non-volatile memory express controller; and
sending the completion message to the host.

9. The method of claim 1, further comprising:
virtualizing an administration queue of the non-volatile memory express controller; and
handling administration queue messages via an administration queue handler hosted by the PCIe interface card.

10. The method of claim 1, wherein the non-volatile memory express controller controls access to a solid state drive.

11. A device comprising:
an interface unit configured to enable network communications;
a memory; and
one or more processors coupled to the interface unit and the memory, and configured to:
receive configuration information for virtual interfaces that support a non-volatile memory express interface protocol, wherein the virtual interfaces virtualize a non-volatile memory express controller;
configure the virtual interfaces in accordance with the configuration information;
present the virtual interfaces to a Peripheral Component Interconnect Express (PCIe) bus; and
receive, by at least one of the virtual interfaces, from a host in communication with the at least one of the virtual interfaces via the PCIe bus, a message for a queue of the at least one of the virtual interfaces that is mapped to a queue of the non-volatile memory express controller.

12. The device of claim 11, wherein the configuration information comprises, for each one of the virtual interfaces at least a namespace identifier, a logical unit number, a memory amount, and a queue pair count.

13. The device of claim 12, wherein the memory amount and queue pair count for respective ones of the plurality of virtual interfaces is different.

14. The device of claim 11, wherein the one or more processors are further configured to:
clone, for each of the plurality of virtual interfaces, PCIe configuration space from the non-volatile memory express controller and store in the memory a resulting cloned PCIe configuration space; and
present the PCIe configuration space to the host.

15. The device of claim 11, wherein the one or more processors are further configured to:
map message signal interrupt resources of the non-volatile memory express controller to the plurality of virtual interfaces.

16. The device of claim 11, wherein the one or more processors are further configured to:
determine whether the message can be serviced locally; and
when the message can be serviced locally, send a response to the message to the host via the PCIe bus.

17. The device of claim 11, wherein the non-volatile memory express controller controls access to a solid state drive.

18. A non-transitory tangible computer readable storage media encoded with instructions that, when executed by at least one processor, is configured to cause the processor to:
receive configuration information for virtual interfaces that support a non-volatile memory express interface protocol, wherein the virtual interfaces virtualize a non-volatile memory express controller;
configure the virtual interfaces in accordance with the configuration information;
present the virtual interfaces to a Peripheral Component Interconnect Express (PCIe) bus; and
receive, by at least one of the virtual interfaces, from a host in communication with the at least one of the virtual interfaces via the PCIe bus, a message for a queue of the at least one of the virtual interfaces that is mapped to a queue of the non-volatile memory express controller.

19. The computer readable storage media of claim 18, wherein the configuration information comprises, for each one of the virtual interfaces at least a namespace identifier, a logical unit number, a memory amount, and a queue pair count.

20. The computer readable storage media of claim 18, further comprising instructions to cause the processor to:
clone, for each of the virtual interfaces, PCIe configuration space from the non-volatile memory express controller and store in the memory a resulting cloned PCIe configuration space; and
present the PCIe configuration space to the host.
